(19) United States
(12) Patent Application Publication
(10) Pub. No.: US 2005/0100073 A1
(43) Pub. Date: May 12, 2005

(54) Cladding-pumped quasi 3-level fiber laser/amplifier

(76) Inventors: Lawrence C. Hughes JR., Corning, NY (US); Xingsheng Liu, Corning, NY (US); Donnell T. Walton, Painted Post, NY (US); Chung-En Zah, Holmdel, NJ (US); Luis A. Zenteno, Painted Post, NY (US)

Correspondence Address: CORNING INCORPORATED, SP-TI-3-1, CORNING, NY, 14831, US

(21) Appl. No.: 10/705,032

(22) Filed: Nov. 10, 2003

(51) Int. Cl. H01S 3/091

(52) U.S. Cl. 372/70

(57) ABSTRACT

An optically active fiber (30) is disclosed for making a fiber laser (18) or an amplifier (16) for optically pumping by a broad area laser diode for operation in the 1.5 micron band. This double-clad structured active fiber (30) has a core (34), doped with an optically excitable erbium ion having a quasi-three-level transition. The core (3) has a core refractive index and a core cross-sectional area. An inner cladding (32) surrounds the core (34). The inner cladding (32) has an inner cladding refractive index less than the core refractive index, an inner cladding cross-sectional area between 2 and 25 times greater than that of the core cross-sectional area, and an aspect ratio greater than 1.5:1. An outer cladding (36) surrounds the inner cladding (32) and has an outer cladding refractive index less than the inner cladding refractive index.

### BACKGROUND OF THE INVENTION

1. Field Of The Invention

The present invention relates generally to in-band, direct, matched or resonant pumping of actively doped Erbium fibers for use as high-power optical amplifiers and lasers for applications ranging from laser-machining and medical arts to telecommunications, and in particular to a quasi 3-level double-clad fiber lasers and quasi 3-level double-clad fiber amplifiers for producing high power 1.5 μm band radiation efficiently in the eye-safe region of the electromagnetic spectrum.

2. Technical Background

The gain medium in a laser or amplifier is composed of atoms or ions having various energy levels. Transition is the process whereby a quantum mechanical system alters from one energy level to another. Such energy levels, also called bands of spectral lines representing the electronic transition in a molecule, form an electronic band spectrum. During this transition process, energy is emitted or absorbed, and it usually takes the form of photons or, phonons—kinetic energy of particles released as heat. Transitions concerned with photons alone are called direct radiative transitions, whereas those having a combination of a photon and a phonon are called nonradiative. Nonradiative transition is the change an atom or ion undergoes when a system is changed from one energy level to another, without the absorption or emission of radiation. The essential energy may be supplied or carried away by the vibrations, such as kinetic energy in the form of heat, in a solid substance or by the motions of the atoms or electrons in a plasma.

Optical pumping is the process whereby the number of atoms or atomic systems in a set of energy levels is changed by the absorption of light that falls on the material. This optical pumping process raises the atoms to specific higher energy levels and may result in a population inversion between certain intermediate levels. Population inversion is the condition in which there are more atomic systems in the upper of two energy levels than in the lower, so stimulated emission will predominate over stimulated absorption.

In general, a laser amplifier is composed of an oscillator, amplifiers, and lenses. The amplifier contains a pump cavity with gain medium which may have the geometry of a rod, slab or other shape. The pump cavity energizes the gain medium which, in turn, produces photons. The photons are incorporated into a beam of coherent energy which traverses the gain medium.

Active, gain or lasing medium is the material, within a laser, that emits coherent radiation as a result of stimulated electronic or molecular transitions to lower energy states. Stimulated emission rather than absorption of light probably will take place at a given wavelength to provide gain in the active laser medium. The medium must have a condition known as population inversion; that is, at least one quantum transition for which the energy level is more densely populated than the lower state.

Excitation potential is a term to refer to the amount of energy required to raise the energy level of an atom; a necessity if the atom is to radiate energy. High excitation potential is the amount of energy in the upper state of the transition involved in the production of a given spectral line. Low excitation potential is the amount of energy, expressed in electron volts, needed to stimulate an atom to the state in which it can absorb the light of a given wavelength.

Pumping band is the group of energy levels to which ions in the ground state are initially excited when pumping radiation is applied to a laser medium. The pumping band usually lies higher in energy than the levels that are to be inverted. When the gain medium is pumped with optical energy from photons, electrons from the atoms of the gain medium are excited from a ground energy state to excited energy states. This difference is called the pump wavelength. The energy difference between the ground and upper laser state is called the transition wavelength. The energy difference between an excited energy state and the upper laser state is called the quantum defect. Heat in the form of photons is emitted when electrons make a transition from an excited energy state to the upper laser state. The quantum defect results in heat generated in the gain medium. The heat produced limits the efficiency of the laser.

When the gain medium is pumped with photons at wavelengths shorter than the transition wavelength, the electrons of the gain medium are excited to higher energy states above the upper laser state. Consequently, a quantum defect is created between the higher energy state and the upper laser state. The relaxation of the electron from the higher energy state to the upper laser state does not produce stimulated emission. Rather, the transition from the higher energy level to the upper laser energy state results in the generation of heat. The larger the gap in energy levels, the greater the amount of heat generated.

Laser radiation typically is produced in a material by a three-level or by a four-level transition system. A three-level laser is a laser having a material, such as solid-state ruby, that has an energy state structure of three levels: the ground state (1) wherein excitation applied to the material raises ions in the material into the broadband level (2) from which the ions spontaneously transfer to a lower, densely occupied level (3) emission of radiation (fluorescence) indicates the spontaneous return to ground level. In a three-level system the lower level for fluorescence is the ground level, i.e., the level with lowest energy, whereas in a four-level system the lower level lies above the ground level.

A four-level laser can also be a solid-state laser consisting of active atoms or ions of a transition metal, rare-earth metal or actinide, imbedded in a crystal or glass material, often garnet. Excitation and transfer to different energy levels are similar to those of the three-level laser. However, there is a fourth, usually unoccupied level above ground level where the laser light terminates before spontaneous decay returns it to ground level.

Three-level systems generally are not as efficient as four-level systems. To create the population inversion necessary for lasing action, one must “pump” atomic, ionic or molecular particles from one or more energy levels to higher energy levels. Since there are significantly more particles populating the ground level than higher energy levels, it is generally quite difficult in a three-level system to obtain the required energy population inversion. In a four-level system on the other hand, the lower laser energy level that is used for laser transitions typically is much higher than the ground level and therefore can be almost completely unpopulated, even at room temperature. In other words, the energy threshold or excitation potential to cause a population inversion at any particular temperature is lower in a four-level energy transition system than in a three-level system, resulting in a higher laser transition probability. Spontaneous transition probability is the probability that an atom in one state will move spontaneously to a lower state within a given unit of time. Because of this higher spontaneous transition probability, four-level laser transition systems are more efficient and more widely used to generate laser radiation than three-level transition systems.

“Quasi-three-level” laser transition systems are also known. A quasi-three-level system is one in which the lower energy state of the laser transition is close to the ground state but yet is a thermally populated state. The lower, thermally populated state generally is in a ground state manifold. In this connection, energy state manifolds are defined in a solid state lasant material by the dopant, whereas the crystalline or glass host plays a significant role in determining the number and location of the energy levels in each of such manifolds. Another term for quasi-three level pumping is resonant pumping which includes resonant absorption and resonance radiation. Resonant absorption is the re-emission of absorbed energy, having the same wavelength as the incident energy, in an arbitrary direction from a particle because of an energy level transition within the material. Similarly, resonance radiation is that radiation emitted by an atom or molecule that has the same frequency as that of an incident particle; e.g., a photon. It generally involves a transition to the lowest energy level of the atom or molecule.

While quasi-three-level transitions have been observed at room temperature, generally high energy thresholds have been required in all prior arrangements to provide the necessary population inversion. This has significantly reduced efficiency.

High power 1.5 μm band radiation is of particular interest in optical communications, military systems and medical systems. This wavelength is eye-safe and coincides with the low loss window of silica optical fibers which are useful for applications that require high-power laser light in the eye-safe region of the electromagnetic spectrum. When configured as an amplifier, the invention applies to optical transmission systems that require high output power such as common antenna television (CATV) and free-space optical (FSO) communications. High power fiber lasers in the eye-safe region of the spectrum are also required for applications including FSO communications and atmospheric sensing.

Most efforts in the past to provide radiation within the 1.51 μm band, i.e., radiation having a wavelength or wavelengths falling between 1.4 and 1.6 μm, have focused on the co-doping of a host crystalline or glass material in a rare-earth doped double-clad fiber laser such as with Erbium:Ytterbium (Er:Yb) co-doped fibers. A rare-earth doped fiber is an optical fiber in which ions of a rare-earth element, such as neodymium (Nd), ytterbium (Yb), erbium (Er) or holmium (Ho), have been incorporated into the glass core matrix, yielding high absorption with low loss in the visible and near-infrared spectral regions. A rare-earth doper fiber laser is then a laser in which the lasing medium is an optical fiber doped with low levels of rare-earth halides to make it capable of amplifying light. Output is tunable over a broad range and can be broadband. Laser diodes can be used for pumping because of the fiber laser's low threshold power, eliminating the need for cooling.

It will be recognized that a co-doping approach is inherently less efficient than one which relies on a single ion for both absorbing pumping radiation and lasing, in view of the need to provide energy transference between ions. For example, the highest efficiency reported for Er:Yb co-doped fibers was 50% with respect to absorbed power due to the relatively low efficiency of the ytterbium to erbium energy transfer process used to excite the lasing erbium ions.

Other known sources of 1.5 μm band radiation are semiconductor diode lasers and solid state lasers, such as an Er YAG laser. A solid state laser is a laser using a transparent substance (crystalline, ceramic or glass) as the active medium, doped to provide the energy states necessary for lasing. The pumping mechanism is the radiation from a powerful light source, such as a flash lamp. The ruby, garnet, and Nd:YAG lasers are examples of solid-state lasers. While semiconductor diodes have the advantage of small size, their beam quality is not satisfactory for many applications and currently commercially available diodes do not have sufficient power and are must less powerful than flash lamps.

### SUMMARY OF THE INVENTION

An optically active fiber is used for making a fiber laser or an amplifier for optically pumping by a broad area laser diode for operation in the 1.5 micron band. This double-clad structured active fiber has a core doped with an optically excitable Erbium ion having a quasi-three-level transition. The core has a core refractive index and a core cross-sectional area. An inner cladding surrounds the core. The inner cladding has an inner cladding refractive index less than the core refractive index, an inner cladding cross-sectional area between 2 and 25 times greater than that of the core cross-sectional area, and an aspect ratio greater than 1.5:1. An outer cladding surrounds the inner cladding and has an outer cladding refractive index less than the inner cladding refractive index.

### BRIEF DESCRIPTION OF THE DRAWINGS

FIG. 1a-b are truncated energy level diagrams of relevant 4f-4f absorption and laser transitions in erbium-doped glass for comparing typical 980 nm pumped erbium in (a) as compared to in-band pumping of (b), according to the present invention;

FIG. 2 is a schematic cross-sectional view of an optically active fiber for optical pumping by a broad area laser diode for operation in the 1.5 micron band, according to the present invention;

FIG. 3 is a graph of output power (milliwatts) at 1605 nm versus input power (milliwatts) at 1535 nm, according to the present invention; and

FIG. 4 is a cross-sectional representation of an ellipsoid or elliptical shape 323 of the inner cladding 32 of the active fiber 30 of FIG. 2, according to the present invention.

### DETAILED DESCRIPTION OF THE PREFERRED EMBODIMENTS

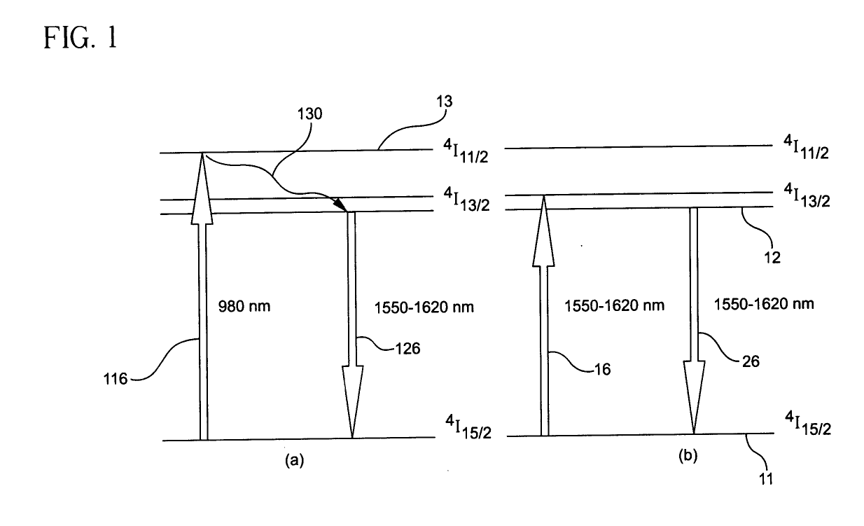

Optical fiber is the favored transmission medium for telecommunications due to its high capacity and immunity to electrical noise. Silica optical fiber is relatively inexpensive, and when fabricated as a single transverse mode fiber can transmit signals in the 1550 nm band for many kilometers without amplification or regeneration. However, a need still exists for optical amplification in many fiber networks, either because of the great transmission distances involved, or the optical signal being split into many paths. Erbium-doped fiber amplifiers (EDFAs) have been found quite effective in providing the required optical gain. As is known, an EDFA is an optical fiber that can be used to amplify an optical input. Erbium rare earth ions are added to the fiber core material as a dopant in typical levels of a few hundred parts per million. The fiber is highly transparent at the erbium lasing wavelength of 1.5 micrometers When pumped by a laser diode, optical gain is created, and amplification occurs. It is well known that an erbium optical fiber amplifier operating in its purely three-level mode is capable, when pumped at a wavelength 116 of 980 nanometers (nm) of amplifying optical signals having a wavelength 126 of 1550 nm, as seen in FIG. 1.

Referring to FIG. 1, an energy level diagram of a trivalent erbium-doped glass is shown. The energy state manifolds illustrated are the ground state manifold, the ⁴I_{15/2} manifold, referred to by the reference numeral 11, the next higher energy state manifold, the ⁴I_{13/2} manifold, referred to by the reference numeral 12, and an upper laser state ⁴I_{11/2}, referenced to by the reference numeral 13. While there are many energy manifolds in an Er doped laser as defined, this ground state manifold 11 and the immediately adjacent higher one 12 define between the two, the wavelength band of interest for the laser radiation and appropriate absorption spectra. The absorption spectrum is also called the spectral window of absorption which is formed by radiation that has been filtered through a material medium, in contrast to emission spectrum. As is appreciated, the ground state manifold 11 includes not only the ground state energy level (identified as level 1) but several other levels being quasi-ground states (not shown). Most of the Er ions are in the ground state level 11 at room temperature. The higher energy manifold 12 is similar to the ground state manifold, in that the energy levels within the same form two distinct closed groups as illustrated, with a first group of levels in one group and a second group of levels in another. It is the lower of these two groups which, with the ground state group in the ground state manifold, defines with one embodiment of the invention both the wavelengths of the radiation of interest and the absorption spectrum to assure that a population inversion and consequent lasing will occur with the single type of dopant. The energy levels in manifold 12 also have very long lifetimes, on the order of several milliseconds, relative to those in manifold 11. It has been found that a 0.1 doped Er glass at room temperature has a major absorption band at 1.51-1.54 μm. While this band includes two absorption peaks located at 1.528.+−.0.001 μm and 1.533.+−.0.001 μm, optical source for pumping is selected having an output energy concentrated in at least one of these absorption peaks.

Traditional pure 3-level pumping of FIG. 1a supplies photons at a substantially higher energy level (shorter wavelength) than the transition wavelength. Conventional diodes pump the gain medium to energy states higher than the upper laser states above the lower laser state. The upper laser state or the higher excited energy is the ⁴I 11/2 energy state 13. The lower laser state is the ₄I 13/2 energy state. The energy difference between the higher excited energy state 13 and the lower laser state 12 results in the production of heat 130 as electrons non-radiatively relax down to the ⁴I 13/2 lower laser state level 12. The production of heat 130 results in a thermal load applied to the gain medium.

Referring to FIG. 1b, the present invention pumps the gain medium with photons having a wavelength which results in the excitation of the gain medium atoms to the lower laser state 12 directly. Since photon pumping does not excite the gain medium to the higher excited energy states, heat emission is reduced. The gain medium electrons are not relaxing from a higher excited energy state 13 to the lower laser state as is the case with flashlamp or traditional diode pumping. The present invention thus reduces the thermal load on the gain medium by controlling the wavelength of photons applied to the gain medium. In accordance with the teachings of the present invention, when an Er doped glass as defined is pumped with an intense 1.5 μm wavelength band source 16, Er ions in the ground state group 11 are excited to the lower energy levels of the upper manifold 12. While in a typical three-level transition system a population inversion is created by pumping the population from the first level of the ground state level 11 to the higher level of the upper laser state 13, for 1.5 μm in-band pumping of Er doped solid-state material meeting the criteria of the invention, the population inversion occurs by pumping the population from the energy levels in the ground state manifold identified as the 2nd and 4th levels of the ground state level 11. They are pumped to the higher levels of the next higher energy state manifold 12. This is represented in FIG. 1 by line 16. At room temperature, while 26% of the population of Er ions in the ground state manifold are at the 1st energy level of the ground state 11, a total of 48% are in the 2nd and 4th levels of the ground state 11. Moreover, because of redistribution of the energy of the ions in the ground state manifold, the pumping process depletes all of such levels. This is quite significant in reducing the pump threshold that is necessary to achieve lasing action. This contributes significantly to the efficiency of the laser as will be discussed below.

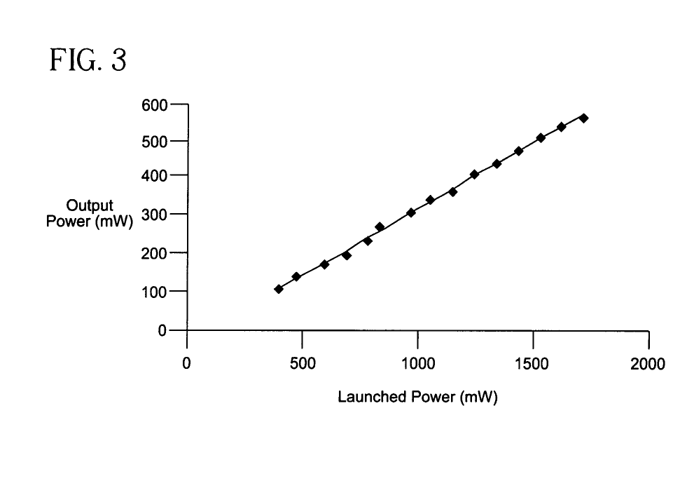

From the energy level diagram of FIG. 1, there is very little difference between the pump wavelength 16 and the laser emission wavelength range 26.This results in highly efficient pump conversion efficiency into output light as evidenced in FIG. 3 where 1530 μm light is shown to require the lowest amount to achieve transparency, and therefore gain, in a double clad fiber geometry. Furthermore, the difference in these two wavelengths 16 and 26, for absorption and emission, respectively, is related to the amount of pump energy that is lost to the system in the form of heat. As this difference is small, especially compared to the traditional pure 980nm pumping of FIG. 1a, for example, the amount of heat is correspondingly small in FIG. 1b.

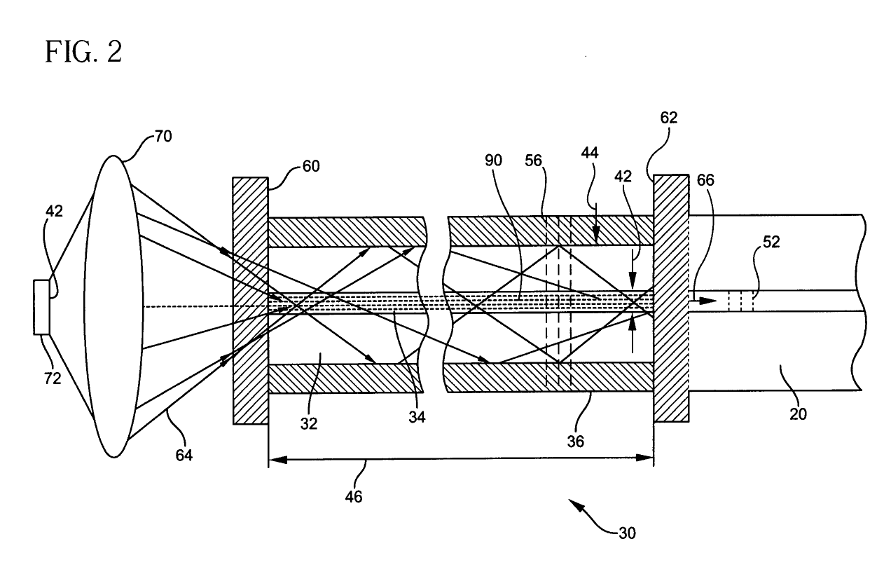

Referring to FIG. 2, a double-clad fiber laser arrangement designed to advantageously utilize the invention is illustrated. The optically-active fiber, brightness converter, fiber amplifier, fiber laser, dielectric waveguide laser or amplifier of the present invention is shown in FIG. 2 and is generally described and depicted herein with reference to several exemplary or representative embodiments with the same numbers referenced to the same or functionally similar parts.

With reference to such figure, a solid-state lasant material, an Er doped silicate glass in a double-clad fiber structure meeting the criteria of the invention, is generally referred to by the reference numeral 30. Both ends of the same are dielectrically coated, left as an fiber/air interface, or having fiber Bragg gratings disposed to have a suitably low reflectivity for the laser and pump radiation. Such a double-clad fiber is located within a laser resonant cavity 46 defined by mirrors 60 and 62, respectively, the mirror 62 having an appropriately reduced reflectivity for the lasing radiation of interest to provide the laser output 66 to an output fiber 20, such as a single mode fiber for an input to an amplifier. The fiber for an amplifier can simply be the same dual-clad fiber 30 but without the mirrors 60 and 62.

The pumping source, a broad area semiconductor laser (BAL) diode, is illustrated as 72 for pumping at a pump wavelength of about 1530 nm. It would be appreciated that the ability to scale to higher powers exits through the use of arrays of BALs in the form of diode bars or stacks.

The output of the pump source 72 is focused via a lens 70 into an inner cladding 32 of the double-clad optically doped fiber 30 positioned to couple the output of the diode pump 64 to the resonator or laser structure. The lasent material or optically-active double-clad fiber 30 has a core 34 doped with optically-active ions or dopants 90, surrounded by an outer cladding 36.

Such an Er-doped double clad fiber will emit 1550-1620 nm coherent radiation when the excited ions decay from the lower group of the upper manifold 12 of FIG. 1 to the ground state group of the lower manifold 11 of FIG. 1. When resonation causes the gain of the 1550-1620 nm band radiation to be higher than its loss for each round trip, the lasant material will emit a laser beam in the 1550-1620 μm band.

The efficiency of a laser is defined as the ratio of output power to input power. It depends on the quantum efficiency (the number of laser photons generated by each absorbed pump photon), the quantum defect (the energy difference between the pump photon and the laser photon) and the pump efficiency, including the pump absorption efficiency of the laser material and the electrical-optical efficiency of the pump source. We can assume a quantum efficiency of 1 with the invention due to the long lifetime of the laser levels in the upper manifold. One of the outstanding properties of this invention is its small quantum defect which allows a quantum energy efficiency of 99%. (The quantum energy efficiency of a laser is the ratio of the laser photon energy to the pump photon energy, determined by (λp/λs) where λp is the pump wavelength and λs is the laser wavelength.) This 99% quantum energy efficiency is extraordinarily high. This small quantum defect, and the concomitant small amount of heat generated, enables output power scaling up to the multiwatt level

An efficient pump source is an InGaAsP/InP or an AlGaInAs/InP diode laser which typically has a quantum efficiency in Watts per Ampere of 30-45%, and an electrical-optical conversion efficiency of 25-40%. As an example, by multimode InGaAsP diode pumping, the pump power absorption efficiency could exceed 90%. Therefore, an optical conversion efficiency of 90% and an overall conversion efficiency of 22-36% can be theoretically achieved.

However, a broad-area laser diode has a width about 50-200 μm wide that is considerably larger than that associated with single-mode operation. For example, a stripe width of 120 μm for the broad-area laser diode to produce multi-moded optical outputs can be used for very high power operation depending on other chip and fiber matching conditions. Their large size allows them to generate higher optical power while still operating at a fairly low power density. However, it is extremely difficult to achieve stable operation with a fundamental (zero-order) transverse mode, the mode of use in pumping a single-mode fiber or an amplifier.

The double-clad structure therefore performs the function of a brightness converter in that it allows for the efficient pumping by a low-brightness multi-transverse mode broad area pump diode 72 of a single mode waveguide in the core 34 of the double-clad structure for the high-brightness output light 66.

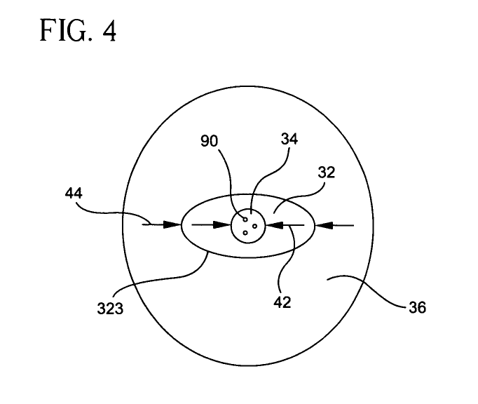

The multi-transverse mode light from the broad area diode 72 is effectively coupled to the erbium doped glass lasent material through the use of coaxial waveguides—the so-called double-clad fiber structure shown schematically in FIG. 2 with a preferred elongated inner cladding 32 cross section as shown in FIG. 4. The double-cladding structure, and a preferred elongated inner cladding 32 that is smaller than a standard Type 2 double-clad fiber, allows for the multimode pump light to be efficiently coupled to single mode output light.

To realize laser oscillation, optical feedback is required in the erbium-doped fiber 30. As the gain in this system is high, feedback can be accomplished through the Fresnel reflection from the air-glass interfaces at the fiber ends. The feedback could also be provided through the use of reflectors 60 or 62, such as dielectric mirrors on the fiber ends or through the fabrication of Bragg gratings into the fiber core 34 or across the inner cladding 32 as a multimode grating. An erbium-doped double clad fiber laser that efficiently couples a multimode input is thus taught by the present invention that is in-band pumped by the high-power 1535-nm broad area laser.

Even without the usage of feedback, the in-band pumped Er-doped double-clad fiber 30 could be useful when configured as a single-pass optical amplifier. Through excitation by the 1535 nm broad area lasers 72, this amplifier is highly efficient and capable of producing high output power levels. When configured as a single pass amplifier, the invention would provide an efficient, high-power amplifier for such applications as CATV.

Hence high power erbium-doped fiber lasers and amplifiers in the eye-safe spectrum are thus taught by the present invention. Through the use of high-power 1535-nm broad area lasers 72 and double clad erbium-doped fiber 30, efficient production of multi-watt levels of single-transverse mode light in the eye-safe region of the electromagnetic spectrum can be realized. The in-band pumping scheme engenders greater power scalability due to decreased heat loss. This structure shares the benefit of low quantum defect and correspondingly high power conversion efficiency.

For 1.5 μm in-band pumping, a powerful pump source is needed to provide the required excitation potential. The single-stripe broad-area diode laser remains the most efficient and least expensive pump source. Recent progress in semiconductor laser technology has led to creation of a single-stripe broad-area laser diodes with output powers of up to 16 W at short wavelengths. Devices 100 μm wide with a slow-axis numerical aperture (NA) of less than 0.1 and output power of 2 Watts at 920 and 980 nm are now passing qualification testing for telecommunication applications, but none have been commercially available at the 1.5 μm band at high power. With proper coupling optics, the beam of such a laser diode can be focused into a spot as small as 30×5 μm with an NA of less than 0.35 in both transverse directions. The optical power density in such a spot is ˜1.3 MW/cm², which should be high enough to achieve transparency in a quasi 3-level laser system if one was available at the 1.5 μm band at high power.

For optimizing the double-clad Er doped fiber structure 30 to the broad area laser diode 72, the recommended value for the clad-to-core area ratio is between about 2:1 to 8:1 because the threshold should be decreased as much as possible for efficient pumping as will be explained theoretically later.

One approach for utilizing inexpensive high-power broad-area pump lasers involves cladding-pumped, or double-clad fiber designs. The advantages of cladding-pumped fiber lasers and amplifiers are well known. Such a device effectively serves as a brightness converter, converting a significant part of the multi-mode pump light into a single-mode output.

Cladding pumping can be used in a fiber amplifier itself, or employed to build a separate high-power single mode fiber pump laser. However, the cladding-pumped technique has been determined in practice to be ineffective for pumping pure three-level fiber lasers.

Practical double-clad amplifiers and lasers have been mostly limited to 4-level systems. Double-clad fiber lasers offer better performance for four-level lasing (where the lasing occurs in a transition between two excited states) than for three-level one (where the lasing transition is between the excited and the ground state).

In the competing and higher-gain four-level-transition case, the doped core is still transparent at the laser signal wavelength when not being pumped. As a result, the power threshold for lasing depends essentially on the dimensions of the doped core and the inner cladding of a double-clad fiber structure, and the background loss in the double-clad fiber over the pump absorption length.

As is known, double-clad fibers allow coupling from diode bars and other similar active structures. However, this is conventionally accomplished by a greatly-reduced pump overlap with the doping profile relative to the signal overlap, since the doping needs to be confined in or close to the signal core in order to obtain sufficient optical gain for the core mode at the signal wavelength. Typically, the core is uniformly doped, and the cladding-to-core area ratio (CCR) between the pump waveguide and the signal core is on the order of 100:1 for conventional double-clad fiber lasers.

Inevitably, the higher gain of competing four-level transitions leads to a high level of amplified spontaneous emission (ASE), which saturates the inversion. Even with weak pumping, the ASE at the four level transition will saturate the amplifier and deplete or otherwise prevent a buildup of the population inversion necessary for lasing at the three level transition. In fact, even without an optical cavity, lasing at the longer four-level wavelength is possible from just the backscattering. Hence, high pump absorption will favor gain at the four level transition or longer even if the laser mirrors, defining the cavity, are tailored for the 3 level transition.

Thus, in quasi-three-level or three-level cladding-pumped fiber lasers, poor overlap of the pump power spatial distribution with the doped area results in a much higher gain of competing four-level laser transitions that require relatively low inversion levels (<5%). It is therefore necessary to suppress the gain of these competing transitions in order to achieve the desired three-level or quasi-three level oscillation at the inversion level required.

Because making the fiber length long enough for a fixed pump power is equivalent to decreasing the average inversion, the fiber length can be intentionally made short enough to avoid lasing at the quasi-four level transition but to preferentially lase instead at the three level transition. However, a short fiber laser is inefficient.

In accordance with the teachings of the present invention, in the specific case of an Er quasi-3-level transition in the 1.5 micron band, with the preferred silicate host glass, such as antimony-silicate, the desired clad-to-core ratio (A_{clad}/A_{core}) is found to be less than eight for an Er double-clad fiber laser.

How much pump light can be coupled into a double-clad fiber inner cladding depends on the cladding size and NA. As is known, the “etendue” (numerical aperture multiplied by the aperture dimension or spot size) of the fiber should be equal to or greater than the etendue of the pump source for efficient coupling. The numerical aperture and spot size are different in both axes so there is an etendue in the x and y directions that must be maintained or exceeded.

Typically, a high numerical aperture NA_{clad}, related to the difference in refractive index between the first and second cladding, is desired. In the well-known design, the first clad layer is made of glass and the second is made of plastic (fluorinated polymer) with relatively low refractive index in order to increase the numerical aperture NA_{clad}. Such plastic may not have the desired thermal stability for many applications, may delaminate from the first cladding, and may be susceptible to moisture damage. Furthermore, the known large-cladding double clad concept is not efficient with three-level transitions.

Even though the ineffectiveness of conventional cladding-pumped high power three-level fiber laser was known, it was not known that it is possible to overcome this ineffectiveness using special design rules.

In general, a double-clad structure that could be used as a fiber laser or as an amplifier includes two claddings. The first (inner) multi-mode clad 32 acts as a multi-mode pumping core. The first cladding or clad 32 is adjacent to a single mode core 34, and a second clad 36 surrounds the first clad 32. The first multi-mode clad or inner cladding 32 serves as a waveguide with a high numerical aperture (N_{clad}) for the input pumping light. The cross-section of the first multi-mode clad 32 (D_{clad} is the longer dimension 44 of the inner cladding as seen in FIG. 4 and FIG. 2) may be designed to have a desired shape, e.g., matched to the near field shape of the pump source (Dₗₐₛₑᵣ is the size of the broad-area laser light emitting aperture 42 in a slow axis as seen in FIG. 2) or any other scheme or shape which increases coupling efficiency of the pump beam. The numerical aperture (NA_{clad}) between the first and second clad layers must be large enough to capture the output of the pump laser diode. The actual increase in brightness realized depends on the clad to core ratio (CCR) of the pump cladding area to the core area, with the higher the ratio (CCR), the greater the brightness increase. However, this disparity in area between the core and cladding cross-sections necessitates a long device length, since the absorption of the pump radiation is inversely proportional to this ratio (CCR). Conventionally high ratio (CCR) of pump cladding area to core area renders achieving a high level of inversion difficult, because in general the higher the ratio (CCR), the lower the level of inversion that can be achieved with a given pump power. Hence, pump absorption and inversion are related.

Using rare-earth element Er as the dopant in the core of the double-clad fiber amplifier/laser with high clad to core ratio (CCR) is thus problematic. Even with the very high power available from a diode laser bar, it is very difficult to reach the high level of inversion necessary for the operation of a quasi 3-level system for lasers or amplifiers.

Three-level transitions require a high inversion of >50% in order to experience gain. Quasi-three-level transitions require lower, but significant inversion levels as compared to four-level lasers, which experience gain for infinitesimally small inversion. In a three-level system, lasing occurs from an excited level to either the ground state or a state separated from it by no more than a few kT (that is, thermally mixed at operating temperature). As a result, an unpumped doped core strongly absorbs at the laser wavelength, and the lasing power threshold can become a problem because of insufficient population inversion.

Referring to FIG. 2, the double-clad structured active fiber 30 has a doped central part or core 34, doped with an optically excitable ion 90 having a quasi-three-level transition requiring a high level of inversion. The core 34 has a core refractive index (n_{core}) and a core cross-sectional area. The cross-sectional area can be calculated from the dimensions 42 of the core. Surrounding the core 34, the inner cladding 32 has an inner cladding refractive index (n_{innerclad}), less than the core refractive index, an inner cladding cross-sectional area between 2 and 25 times greater than that of the core cross-sectional area (2<CCR<25), and an aspect ratio greater than 1.5:1. This preferred design and dimensions of the double-clad active fiber 30, allows strong pump absorption, greater than 6 dB, while suppressing long wavelength ASE. The inner cladding cross-sectional area can be calculated from the dimensions of the inner cladding, which includes a longer dimension 44, as taught by the present invention and can be exemplified by FIG. 4.

Referring back to FIG. 2, the outer cladding 36 surrounds the inner cladding 32 and has an outer cladding refractive index less than the inner cladding refractive index.

As an example for use of the double-clad active Er-doped fiber 30, a laser structure is shown in FIG. 2. On the pumped end of the active fiber 30, a 100% signal reflective and pump transparent mirror 60 is placed. Signal reflection of about 4% is provided on the output end, with an optional output mirror 62. The preferred clad-to-core area ratio or overlap ratio of Γ_{S}/Γ_{P} can be found, and a maximum ratio of 7.6 is found and taught by the present invention for the rare-earth dopant Er for use in an Er fiber laser in the 1.5 micron band.

In general, the active fiber 30 of FIG. 2 can be used as an amplifier or fiber laser. The present invention teaches a maximum allowable inner cladding area for the double-clad structure for doping with Er. Generally, given the pump absorption cross-section (σₐₚ), the metastable level lifetime (τ) and the desired level of average inversion (\overline{n}₂), and the available pump power from any type of a laser diode such that assuming a particular power absorption, input and output (unabsorbed) pump power values can be estimated as Pᵢₙ and Pₒᵤₜ, respectively, the maximum permissible cross-sectional cladding area can be found using the following equation, as taught by the present invention for any rare-earth and host material system:

$${A}_{clad} \leq \frac{{σ}_{ap} τ ( 1 - {\overline{n}}_{2} ) ( {P}_{i n} - {P}_{out} )}{h v {\overline{n}}_{2} ln ( {P}_{i n} / {P}_{out} )} \qquad ( 1 )$$

where hν is the pump photon energy.

Despite all the differences between ions and host materials, Equation (1) is universally applicable, and especially suited for amplifiers operating well below saturation. In general, it is not the clad-to-core ratio (CCR), but the absolute size of the inner cladding that is most critical for efficient laser or amplifier operation. Accordingly, the core 34 can be any size that fits inside the inner cladding 32 of FIG. 2.

However, it is preferable that the core 34 is similar in size and NA to standard single-mode fiber 20, which would facilitate coupling to the output fiber 20 for the laser or facilitate coupling to both the input and the output of the amplifier. The typical single-mode core radius is about 3 to 4 um.

In calculating the preferred size of the inner cladding of a double-clad fiber amplifier is based on silica glass codoped with non-active dopants Ge and Al (type II) the cross-sectional area of the inner cladding is found to be: A_{clad}≈780 μm². What this means is that for an inner cladding cross-sectional area larger than 780 square microns, an average inversion of 0.6 will not be achievable unless a more powerful pump laser (more available power than 2W) is used. In practice, passive losses will limit the useable size of the inner cladding to even lower values, of an order of 500 μm² or less.

If the available power is doubled in the laser diode as in a 4 W pump diode, recommended values are then also doubled such that the inner cladding area is less than 2000 μm² and more preferably less than 1500 μm².

With the small waveguide dimensions and preferred all-glass design taught by the present invention, direct end pumping is the preferred choice. The present invention additionally teaches that what is important for quasi-3-level devices, such as lasers or amplifiers, is the level of pump power density that can be created in the inner cladding, which defines the achievable inversion. In accordance with the teachings of the present invention to find the maximum desired area of the inner cladding, it is more convenient to use the power threshold estimate equation for a laser.

For any 3-level device the threshold pump power Pₜₕ in a laser always has to be higher than the saturation power Pₛₐₜ. In other words the fiber laser must be “bleached” (i.e., where approximately one-half lasing atoms have been excited into an excited state) along a substantial part of its length. Pₛₐₜ is the saturation power defined as

$${P}_{sat} = \frac{h ν}{{σ}_{ap} τ} {A}_{clad} \qquad ( 2 )$$

Hence, the smaller the inner cladding area (A_{clad}) the lower is the saturation power Pₛₐₜ because these two terms are directly related by Equation (2). It can be seen that the smaller the saturation power is, the greater the inversion because these terms are inversely related, hence the higher inversion can be achieved to make a quasi-3-level laser work.

The threshold power Pₜ scales in proportion to the cladding area (A_{clad}) and the length of the laser. The threshold pump power is well approximated by the following equation where it can be seen that the threshold pump power is higher than the saturation power by a factor αₚ/4.343 when the fiber laser is bleached:

$${P}_{th} = {P}_{sat} ( {α}_{p} / 4.343 ) = \frac{h ν {A}_{clad}}{{σ}_{ap} τ} ( {α}_{p} / 4.343 ) \qquad ( 3 )$$

where σₐ is the pump absorption cross section, τ is the fluorescent or metastable level lifetime, A_{clad} is the cross-sectional area of the inner cladding, and αₚ is the pump absorption in dB. Hence, from Equation (3), the power threshold for lasing depends essentially on the dimensions of the inner cladding and the background loss in the active fiber over the pump absorption length.

However, the practical size of the minimum area of the inner cladding will be limited by the choice of materials (NA_{clad} and the index contrast or index delta) and the quality of pump focusing optics. With a cladding aspect ratio of 2 or higher it would be impossible to have a cladding to core area ratio CCR of less than 2, unless the core is elliptical too. Furthermore, with conventional optics it is very difficult to focus a 100 um or wider broad area laser 72 into a spot smaller than 20 um in size, and it is not practical to make a single-mode core larger than 10 um because the required index contrast or index delta will be too low. This, again, dictates that minimum CCR is about two.

In a double-clad amplifier with a small clad-to-core area ratio (CCR), cladding modes of the signal will overlap with the doped core to a sufficient degree to experience gain in the higher-order modes (HOM). Any mode of the waveguide has a certain profile of the optical field. The waveguide mode is only amplified as much as that field overlaps with the doped region (for the description given here, we assume that only the core is doped, although partial doping of the cladding is also possible). Most of the field of the fundamental core mode is within the core 34, and that mode would obviously be amplified, if the required level of inversion were achieved. However, the inner cladding supports many different modes because of its larger size. Some ions will always transition spontaneously, giving equal amount of photons to every mode, core and cladding. If the cladding is comparable in size to the core, at least some of the higher-order inner cladding signal modes will have a sufficient overlap of their field with ions in the core to also be amplified. The overlap will degrade the laser or amplifier efficiency, because optical energy accumulated in the higher-order cladding modes (ASE) will not be coupled to a single-mode output fiber.

One solution, for the amplifier, is to perfectly mode-match the input and output single-mode fibers 20 interfacing to the double-clad fiber core mode of the active fiber 30, used as an amplifier, so that very little light is launched into cladding modes of the amplifier. Otherwise, launching any light into the cladding modes of the amplifier would degrade its efficiency because some pump energy would be wasted on amplification of the cladding modes and never converted into a useful output. To mode match the input fiber to the core mode of a double-clad fiber, when the fibers are spliced, it is taught to ensure that mode field diameter (MFD) is the same for the input fiber and the double-clad core. Even though actual index differences or index delta and core diameters may differ, what is needed is to match the MFD and align cores well.

Another solution that the present invention teaches, for the laser, is to use mode-selective feedback to ensure a fundamental mode-only laser operation. To provide mode-selective feedback, the output single-mode fiber is mode-matched to the double-clad fiber core mode and an optional signal reflector 52, in the form of Bragg gratings or another type of a reflector is provided in the output fiber, to ensure stronger optical feedback for only the core mode. If the internal loss is sufficiently small, then the laser efficiency is relatively insensitive to the external reflection. Therefore, a 4 to 15% external reflector will not significantly decrease the efficiency. However, once the reflector 52 is placed in the single-mode output fiber 20 and the fibers are mode-matched, only one mode, the core mode of the double-clad fiber laser 30, will receive the feedback, and the cladding modes will not. Hence, the reflector 52 reflects the signal light to perform a mode selection function. The presence of the reflector 52 and mode matching will ensure that cladding modes never lase.

Alternatively, the output mirror 62, preferably in the form of a suitable thin-film stack, can take the place and eliminate the need for the Bragg reflector 52 and an additional optional pump reflector 56. Since the present invention teaches that a high inversion level should be maintained throughout the whole length of a quasi-3-level laser or an amplifier, a significant amount of pump power would pass through and escape on the other end. Therefore, for maximizing the laser/amplifier efficiency, it would be preferable to use an additional multimode pump reflector 56 to reflect the residual power back into the device as seen in FIG. 2. A flat mirror, displaced by a small distance from the fiber end acting as a pump reflector, could also provide some mode-selective feedback for the signal, if it is designed to reflect 100% at the pump wavelength and 5-15% at the signal wavelength.

In the case of a laser, the output flat mirror acting as the pump reflector 56 can simply be a dielectric mirror deposited on the cleaved or polished end of the fiber, transparent for the signal and highly reflective for the pump.

In the case of using the active fiber 30 as an amplifier, however, even a very small amount of signal reflection can cause undesirable multi-path interference effect. If a material of the inner cladding 32 is photosensitive, then an advantageous solution for the amplifier 16 is to write a multimode chirped fiber Bragg grating (FBG) 56 at the unpumped end of the active fiber 30 designed to reflect all or most of the pump modes.

In general, maximizing the overlap between pumping light and doped fiber core is advantageous. Thus it is desirable to make the core larger and inner cladding smaller. A larger core improves pump absorption and smaller inner cladding helps create higher inversion with less pump power. However, other factors already discussed and to be seen, limit the optimum core size to the one corresponding to a nearly two-moded core. Due to physics, a cladding-to-core area ratio (CCR) greater than 5 or 6 is needed. Given the current material choice and capabilities of coupling optics, there is a limit to which the cladding size can be decreased before the pump coupling efficiency will start to suffer. Given that minimum cladding size, the only way to decrease the clad to core area ratio (CCR) below 5 or 6 is to start making the core larger and larger.

However, the index difference or delta between the core and the inner cladding cannot be made too small, or the optical field will simply not be confined in the core, as already discussed, and the core waveguide will have too much bend loss. Hence, with a given index difference or delta, one can only increase the core diameter 42 of FIG. 2 and FIG. 4 so much before the core becomes multimoded (up to about 10 um, in practice), unless the core is made with a graded index. It is known that for a given delta, a slightly larger core can still be single moded if the core has a graded index. If the inner cladding waveguide has a noticeable amount of passive loss, a larger size graded index core allows it to absorb the same amount of pump power in a shorter fiber length, increasing the device efficiency. Grading of the core index profile can be achieved, for example, by annealing the core-inner cladding preform or drawing it at a higher temperature, allowing for significant dopant diffusion. When the core is molten and the cladding is softening, diffusional processes are relatively fast, so graded index profiles can be created in situ.

An ultimate version of the graded index is a core that grades down in index all the way to the edge of the outer cladding. Then, there is no defined border between the core and inner cladding, they become one. And still the 0-order or fundamental mode of such a waveguide is confined in its very center with a relatively small MFD, and the higher order modes fill the total waveguide area more uniformly. Hence, the present invention also teaches an analog of the area ratio (CCR) where it is the modal area ratio that is specified rather than the glass layers area ratio.

As discussed, many factors affect the optimum design of a double-clad fiber used as a waveguiding structure. A number of modes and their intensity (field) distribution within the waveguide depend on the waveguide shape, index contrast or index delta Δ, and size.

For the case when a line between the core and the inner cladding (graded index) is hard to draw, the physical cross-sectional area ratio (CCR) is not simply defined. In this unique case of a high-delta graded waveguide used as both the core and the inner cladding of a “double-clad” fiber, the modal area is defined as the physical area where the optical intensity of the mode is higher than 1/e² of its maximum (or electric field amplitude is higher than 1/e of its maximum). In other words, when the core and the inner cladding form a single waveguide made of a material with a continuously varying composition such that the refractive index is progressively decreased (graded) from a central part to an edge of the waveguide, the central part of the waveguide is doped with the optically active ion having the three-level transition to form a doped area, then the overlap between the fundamental (zero-order) signal mode of the waveguide with the doped area is preferably designed to not be more than seven times larger than the overlap of all pump modes of the waveguide combined with the doped area.

The direct analog for the physical cross-sectional area ratio (CCR) would then be the ratio of a/b where “a” is the cross-sectional area of all propagating pump modes combined and “b” is the cross-sectional area of the fundamental (zero-order) signal mode. All modes in this case are modes of the graded waveguide which is both the core and the inner cladding. However, the pump will use all of these modes and the signal ideally will propagate only in the zero-order one, giving the desired ratio of about 3:1 to 5:1 for a reasonably high delta. This 3:1 to 5:1 modal ratio of the cross-sectional area of all propagating pump modes combined over the cross-sectional area of the single signal mode is especially beneficial for the Er quasi-3-level laser.

A similar definition can be given for the standard case, when the core and the inner cladding have a clear border, because once again, the pump uses many modes of the cladding and the signal only uses one mode of the core. However, for the standard case this definition would give almost exactly the same numerical value as the physical cross-sectional ratio (CCR).

Optically, for conserving “etendue”, the product of the NA_{clad} and spot size of the double-clad fiber 30 has to be equal or greater than the product of the numerical aperture (NAₗₐₛₑᵣ) and the spot size on the laser diode 72 of FIG. 2. If optics is used to de-magnify the image of the laser emitting area, the same optics will automatically make a beam more divergent, or increase its NA. The inner cladding 32 (serving as a pump waveguide) NA, NA_{clad} must then be equal or higher than that of the incoming beam, to collect all of the light. The general definition for the NA refers to the maximum divergence angle at which a light beam can enter a waveguide and still experience total internal reflection needed for waveguiding. For a typical 100 μm broad stripe laser or wider, the divergence angle parallel to the stripe (slow axis) corresponds to an NA of approximately 0.1. A fiber NA greater than 0.35 is then desired for the efficient coupling of the pump light into a 30 μm core. For a 15 μm core, an NA of 0.7 is needed.

These NA values represent a very high refractive index contrast, or delta between the inner cladding and the outer cladding and are higher than available in standard silica fibers. However, they can be achieved with multi-component glasses. Tantalum silicate and lanthanum aluminum silicate fibers have been fabricated with a high refractive index relative to silica. Antimony silicate fibers using different compositions for the core and the inner cladding have also been fabricated with a high refractive index relative to silica. Almost any multi-component fiber will give a high refractive index, for example, those based on phosphates, lead silicates, and germanates, as the composites. However, the chemical and physical properties of the core must be compatible with the inner cladding, and spectroscopic properties of the dopant must be preserved.

The NA of the fiber waveguide also relates to the minimum size, and therefore, as shown above, to the threshold power value for a particular aspect ratio. The elongated inner cladding 32 can be of various shapes, for example being rectangular instead of elliptical. As the aspect ratio of the rectangular multi-mode inner cladding drops, the threshold power for lasing is significantly decreased. For rectangular aspect ratios of more than 4/π or 1.27, the rectangular inner cladding has a smaller threshold power for lasing than a circular one. For example, for a waveguide with a numerical aperture of 0.6, the threshold power for lasing is reduced from 900 mW for a circular inner cladding of a 33 μm diameter fiber to 200 mW for a rectangular inner cladding of the fiber waveguide having an aspect ratio of 3 (33 μm×11 μm). These dimensions are consistent with image sizes of broad stripe diode lasers 72. This reduction in threshold power for lasing is greatly advantageous if a 2-4W diode is the limit of broad stripe pump sources 72.

As is known, for efficient coupling of the pump light, the inner cladding geometry of a double-clad fiber should match the geometry of the pumping diode. Unfortunately, the light emitting spot of a broad-area semiconductor laser 72 is strongly asymmetric, with an aspect ratio of at least 100:1. The beam is typically single-moded (Gaussian) in the fast axis direction (perpendicular to the wafer plane) and strongly multi-moded in the slow axis direction (parallel to the wafer plane). The slow axis direction is the most critical one, ultimately defining the allowable size of the pump waveguide or fiber laser.

The present invention teaches a variety of elongated shapes that can be used for the inner cladding 32 of FIG. 2, the most technologically convenient ones being the rectangular inner cladding, a “racetrack” inner cladding, in addition to the ellipse inner cladding 32 of FIG. 4. The longer (slow axis) dimension 44 should be at least 10-20% larger than the width of the diode laser aperture (Dₗₐₛₑᵣ 42 of FIG. 2) times the ratio of the diode slow axis NAₗₐₛₑᵣ to the fiber NA. For example, if a 100 μm laser with 0.1 NA is used for pumping and the fiber inner cladding NA is 0.3, then the longer dimension of that cladding should be at least 1.2·100/3=40 μm. To keep the cross-sectional area of the cladding as small as possible, the shorter (fast axis) cladding dimension should be made just large enough to accommodate the single mode core. Resulting aspect ratio of the cladding will then be 1.5:1 or higher. Oblong or an otherwise elongated shape of the inner cladding combined with the relatively small clad-to-core area ratio (CCR), will ensure uniform pump absorption by equalizing pump modes overlap with the doped core. Other possible elongated shapes include a diamond shaped inner cladding, a “Saturn”-like inner cladding, having an elongated center elliptical extension in the middle of a just larger circle than the circle of the core, will have the smallest possible clad-to-core area ratio (CCR) for a given core size.

Referring back to FIG. 2, the preferred design and dimensions of the double-clad active fiber 30, allows strong pump absorption while suppressing long wavelength ASE and allows a strong enough pump intensity to obtain quasi-3-level operation, summarizing the teachings of the present invention. The input side of a quasi-3-level or a quasi-3-level double clad active fiber or brightness converter 30, for use as an amplifier or a laser, is irradiated with a pump signal 64 at wavelength λₚ. The inner cladding 32 is constructed for multi-mode operation. A preferably-single-transverse-mode core 34, centrally located within the inner cladding 32, is made from glass having a sufficient compositional difference from the inner cladding 32 to provide the appropriate differences in refractive indexes. The core 34 does not have to be strictly single mode, a core on the border of being 2-moded still works. For our stated purposes, the core 34 is doped with erbium (Er³⁺) ions. The double-clad active fiber 30 also includes an outer cladding 36 that is preferably made of a glass with a lower refractive index than the refractive index of the inner cladding 32 such that the NA_{clad} is greater than 0.3. An all-glass design allows these types of refractive indexes and the glass types include lanthanum aluminosilicate glasses, antimony germanates, sulfides, lead bismuth gallates, etc. A preferred material for the overclad is also a glass, for example, an alkali of boroaluminosilicate.

No attempt has been made to accurately illustrate their relative diameters in the cross-sectional area representations of the active fiber 30 in FIG. 4. However, the area of the inner cladding 32 is preferably approximately less than twenty-five times larger than the area of the core 34.

The length of the active fiber 30 is relatively unimportant beyond it being very long compared to the wavelengths involved so that any higher-order modes are adequately attenuated over its length. In practice, this length is determined by the level of rare earth doping in the core and desired pump absorption efficiency. In some circumstances 1 cm in length is more than adequate.

Instead of using a separate focusing element 70, the optical characteristics of the broad stripe laser 72 may be good enough to allow direct coupling into the multi-mode inner cladding 32. However, if a focusing element 70 is needed, techniques have been developed that enable efficient coupling of pump power from broad-area laser diodes having typical emitting apertures with dimensions of 100×1 μm² and NA's of 0.1/0.55 in the slow and fast axes, respectively, into a fiber with a rectangular core cross section of 30×10 μm² and effective numerical aperture of >0.42. The terms “slow” and “fast” refer to the planes that are “parallel” and “perpendicular,” respectively, to the laser diode junction plane. In order to efficiently couple light from the broad-area semiconductor laser 72 with emitter dimensions of 100×1 μm² and NA's of 0.1/0.55 in the slow and fast axes (measured at 5% of the maximum far-field intensity points), respectively, coupling optics or other beam shapers 70 can be designed to produce an image of the emitter near field with dimensions of 30×10 μm² and 5 % NA's of 0.35/0.12 in the slow and fast axes, respectively.

As illustrated in the schematic view of FIGS. 2 and 4, the similar elliptical, rectangular, oblong, or otherwise elongated aspect ratios of the diode or broad-area laser 72 and of the input of the multi-mode cladding 32 (both vertically or horizontally aligned alike) allows a lens or fiber-optic coupler, optical exciter, or other beam shaper or focusing element 70 to focus the relatively large-size output of a wide stripe or “broad area” laser diode 72 or even a diode bar into the wide multi-mode cladding 32 of the fiber laser/amplifier or other types of brightness converter 30. Preferably, the inner cladding 32 has an aspect ratio greater than 1.5 and sized sufficiently small to allow the coupling of pump light from the broad-area laser diode 72 to create sufficient high pump power density. The inner cladding of the double-clad fiber can be drawn into elongated shapes, for example, ellipses or rectangles by various methods. Available methods include triple-crucible draw and the rod-in tube technique, with the parts machined into a desired shape. CVD, sol-gel, and soft glass in tube are other available methods.

The rectangular, elliptical, oblong, or other elongated cross section of the multi-mode cladding 32 of FIG. 4 is particularly advantageous because its entrance face 323 can be more easily matched to the emission pattern of a wide stripe laser 72, which may have a width-to-height aspect ratio (AR) of 100:1. That is, the width of the waveguide entrance face 323 can be made substantially greater than its height, which is defined as a high aspect ratio. Even if the coupling optics is designed to form a beam which, when demagnified from the original 100×1 μm size, has approximately equal NA in both orthogonal directions (advantageous for preserving a high power density), the resulting beam waist will still be substantially wider in the plane of the diode chip than it is in the vertical direction, for example, 30×5 μm. If the cladding waveguide cross-section matches that shape, then nearly all of the laser diode power can be easily coupled into the waveguide while maintaining a high optical pump power density. The high power density allows a lower power threshold for lasing than that available in circular or square waveguides. Other inner cladding cross-sections of other elongated shapes, for example, rectangular, “racetrack”, diamond, “saturn”, or any other beam-matching shape, can be used to match the shape of the pump emission area. However, it is desirable for the output of the fiber laser/amplifier or brightness converter 30 to have a substantially circular single-mode transverse field as its output from the core 34. It is desirable for the output of the fiber laser/amplifier using the fiber 30 to have a substantially circular mode field because a conventional fiber 20 also has a circular mode field and the better the mode field size and shape match, the lower the coupling loss.

For any given NA of the inner cladding, the longer dimension of the double-clad fiber will be fixed by the requirements to couple all of the available pump power (since the size of a broad-area laser emitter is fixed and can be demagnified only by the amount defined by the fiber NA relative to the broad-area laser NA). The second or shorter dimension can then be varied. However, if the longer dimension is the same, an elongated shape with an aspect ratio of 3:1 will have a surface area 3 times less than the one with a 1:1 aspect ratio. Therefore, a corresponding laser with such a smaller surface or cladding area can have roughly 3 times lower threshold. A lot of factors in designing an optimum quasi-3-level double-clad fiber laser or amplifier relate back to the cladding to core area ratio (CCR). With a given fiber NA and pump laser NA, one of the dimensions of the inner cladding can not be decreased below certain size. But to decrease the surface area as much as possible for higher inversion, in accordance with the teachings of the present invention, the other dimension can be squeezed. Thus, the present invention teaches that neither the area nor an aspect ratio specification by itself is sufficient for building an efficient device and only complying with both specifications at the same time can provide sufficient inversion and low threshold.

As well as for a laser, the active fiber 30 used as an amplifier utilizes the multi-mode inner cladding to receive the pump light 64 for coupling to the core which provides most of the optical amplification. The single-mode fiber output fiber is butt coupled at an output junction of the active fiber 30, for example by a splice or other connection, and effectively outputs a lasing signal 66 that is only the fundamental mode. Preferably, the mode field diameters (MFD) for the respective lowest-order modes are matched across the junction between the output end of the active fiber 30 and the single-mode fiber. If not index-graded, the core is sized sufficiently small such that the core supports only one transverse mode at the output signal wavelength such that this single transverse mode has a mode field diameter equal to that of a standard single mode fiber for optimum coupling.

As an example, a multi-component silicate glass as the inner cladding 32 is placed within an outer cladding 36 having a diameter of 125 micron and has a core 34 having a core diameter 42 of 6 micron, to provide an output mode closely matched to a CS980 single-mode fiber 20. Preferably an antimony sillicate glass is used. Another multi-component silicate glass is 60SiO₂ 28Al₂O₃ 12 La₂O₃ (in mole %). Even though other single-mode fibers are usable, the single-mode fiber 20 is the CS980 single-mode fiber made by Corning, Inc. for propagating wavelengths at 980 nm and having a standard 125 micron outer diameter.

Minimizing the mismatch of the coefficient of the temperature expansion (CTE) is very important for increasing fiber reliability and to facilitate the cleaving and end-polishing of the fibers. A less than ±30×10⁻⁷/oC over the range 0-200 oC CTE mismatch is preferred between the inner cladding and outer cladding. The most important point of mismatch is between the inner and the outer clad, though the core to clad CTE mismatch could be important for polishing. Hence, the core is preferably also made from a glass having a coefficient of thermal expansion (CTE) mismatch with the material of the inner cladding of less than ±30×10⁻⁷/oC over the range 0-200 oC. These requirements are relatively easily met using antimony silicates, alumino-lantano-silicates, alumino-phospho-germanosilicates and a variety of other oxide glasses. For some fiber-making techniques, such as triple-crucible draw, it is also important to match the viscosities of the core, inner and outer cladding glasses for better control over a waveguide shape.

### EXAMPLE

A singly-doped erbium double-clad fiber laser was pumped with a high power broad area laser 72 at 1535 nm. This technique yielded a slope efficiency of 70%, limited primarily by the higher background loss in the non-optimized fiber 30. The double-clad erbium-doped fiber 30 had an elliptical inner cladding 32 with dimensions 37.8 μm×12 μm. The circular core 34 had an 81 μm diameter. The numerical apertures between the inner cladding 32 and outer cladding 36 and between the core 34 and inner cladding 32 were 0.45 and 0.1, respectively. The erbium concentration was 1000 ppm (mol) which is a dopant concentration of 0.1% (1000/1000000). A 10 m section of fiber 30 was used in the laser. The antimony-silicate fiber 30 was produced using a triple crucible method.

The pump laser 72 was a single-stripe broad area laser operating at 1535 nm. The active region is made of AlGaInAs multiple quantum wells within the graded index separated confinement structure grown by MOCVD. The injection current is confined by a nitride layer. The 1535 nm broad area laser 72 was epi-down mounted to a copper heatsink using indium solder. The emitter dimensions were 80×1 μm². To provide higher power, the stripe can be increased to about 120 micron wide. The pump wavelength was 1535 nm. The maximum output power was 4 W. The numerical apertures for the fast and slow axes were 0.4 and 0.1, respectively. The broad area laser 72 was coupled into the inner cladding 32 of the double clad fiber 30 using a 3:1 demagnifying microlens 70 (available from LIMO). The launch efficiency of the pump was 70%.

The laser cavity feedback was provided by the 5% Fresnel reflections from the air:glass interfaces at each fiber facet. The output power characteristic of the laser is depicted in FIG. 5. The maximum single-sided output power was 600 mW at 1605 nm. The maximum launch efficiency of 70% was determined using a 3 m length of fiber with identical inner cladding dimensions, but no core. The transmission of the microlens was 83% due to the absence of anti-reflection coatings on the transmission surfaces. The working distance between the broad area laser 72 and the lens 70 was 30 μm. The distance between the lens and the fiber facet was 1251 μm. These tight constraints precluded the use of bulk dichroics to directly ascertain the amount of output power from the pump launch end of the fiber. Dielectric coated facets and Bragg gratings written directly into the core or across the inner cladding to provide feedback at the launch end could be used for further optimization. Further improvements should be achieved by increasing feedback at the pump end of the fiber either through a dielectric coated high reflector or an intracore or intra-inner cladding fiber Bragg grating.

Hence, according to the teachings of the present invention, the core cross-sectional area is dimensioned such that the higher-order modes of the inner cladding experience a lower overlap with the doped area than the fundamental mode.

It will be apparent to those skilled in the art that various modifications and variations to the options and design criteria of the double-clad structure, such as the lens, coupling scheme, fiber laser, amplifier, and other components of the optical package can be made to the present invention without departing from the spirit and scope of the invention. Thus, it is intended that the present invention covers the modifications and variations of this invention provided they come within the scope of the appended claims and their equivalents.

1. A quasi-three-level optical device comprising:
a solid-state lasant material made up of a host material of silicate glass and a plurality of dopant particles of single tri-valent Erbium (Er) optically-active ions within the silicate glass which is in a concentration which is not sufficiently high to provide significant energy transfer between the dopant particles, the lasant material having a single ground state energy manifold and at least one other higher energy state manifold, both of which have a plurality of energy levels defining between the manifolds one or more wavelengths at which optical energy is absorbable and the one or more wavelengths making up the desired radiation;
a source of optical pumping energy having an optical output concentrated at one or more wavelengths which are generally the same as the one or more wavelengths which are absorbable; and
optics for coupling optical pumping energy from the source into the solid-state lasant material to cause a population inversion or inversions between energy levels of the two manifolds.

2. The optical device of claim 1, further comprising a resonant cavity enclosing the solid-state lasant material selected to oscillate the desired radiation within the material and for generating an output radiation from the resonant cavity.

3. The optical device of claim 1 wherein the one or more wavelengths at which optical energy is absorbable and the one or more desired radiation have wavelengths in the range between about 1530 nm and 1620 nm.

4. The optical device of claim 1 wherein the source of optical pumping energy is a semiconductor diode having a pump output approximately matched with the absorption spectrum defined by energy levels of the two manifolds.

5. The optical device of claim 1 wherein the solid-state lasant material is singly Er⁺³ doped antimony silicate in a double-clad fiber.

6. The optical device of claim 1 wherein the ground state energy manifold and the one other higher energy state manifold respectively are the ⁴I_{15/2} and the ⁴I_{13/2} manifolds of the material.

7. The optical device of claim 1 wherein the wavelength at which the optical pumping energy is concentrated is between 1450 nm and 1600 nm.

8. The optical device of claim 1 wherein the material has about 1000 ppm (mol) erbium doping.

9. The optical device of claim 1 wherein the material comprises an optically active double-clad fiber for making a fiber laser or an amplifier, the fiber comprising:
a core, doped with the optically excitable Er ion having a three-level transition, the core having a core refractive index and a core cross-sectional area;
an inner cladding, surrounding the core, the inner cladding having an inner cladding refractive index less than the core refractive index, the inner cladding having an inner cladding cross-sectional area between 2 and 25 times greater than that of the core cross-sectional area, and the inner cladding having an aspect ratio greater than 1.5:1; and
an outer cladding surrounding the inner cladding, the outer cladding having an outer cladding refractive index less than the inner cladding refractive index.

10. The optical device of claim 9, wherein the core is sized sufficiently small such that the core supports only one transverse mode at the output signal wavelength, and the only one transverse mode has a mode field diameter equal to that of a standard single mode fiber for optimum coupling.

11. The optical device of claim 9, wherein the core is doped with the optically excitable Er ion having the three-level transition at about 1550-1620 nm, when optically pumped at about 1535 nm, the inner cladding having the inner cladding cross-sectional area between 2 and 8 times greater than that of the core cross-sectional area.

12. The optical device of claim 9, wherein the core and the inner cladding are made from different compositions of antimony-silicate glass.

13. The optical device of claim 9, wherein the difference between the outer cladding refractive index and the inner cladding refractive index is large enough to ensure that the inner cladding numerical aperture NAclad satisfies the condition
NA_{clad}>NAₗₐₛₑᵣ*Dₗₐₛₑᵣ/D_{clad},
where NAₗₐₛₑᵣ is the numerical aperture of a broad-area pump laser as the source of optical pumping energy in a slow axis,
Dₗₐₛₑᵣ is the size of the broad-area laser light emitting aperture in a slow axis and
D_{clad} is the longer dimension of the inner cladding.

14. The optical device of claim 9, wherein the difference between the outer cladding refractive index and the inner cladding refractive index is large enough to provide a numerical aperture (NA) greater than 0.3.

15. The optical device of claim 9, wherein the inner cladding is made from a glass having a coefficient of thermal expansion (CTE) mismatch with the material of the outer cladding of less than ±30×10⁻⁷/° C. over the range 0-200° C.

16. The optical device of claim 9, wherein the core is made from a glass having a coefficient of thermal expansion (CTE) mismatch with the material of the inner cladding of less than ±30×10⁻⁷/° C. over the range 0-200° C.

17. The optical device of claim 9 wherein the source of optical pumping energy comprises an array of broad area laser diodes for scaling to higher powers.

18. The optical device of claim 9, wherein the inner cladding has a generally elliptical cross-section with dimensions about 37.8 μm by 12 μm.

19. A quasi-three-level fiber laser comprising:
a broad-area laser diode having a single stripe of about 50-200 μm wide for providing a pump light having a high output power;
a double-clad optically active fiber having a first end for receiving the pump light and a second end for outputting a laser signal, the double-clad optically active fiber including
a core for supporting close to a single-mode transmission of the laser signal, the core having a cross-sectional core area, the core doped with a plurality of optically excitable Erbium dopants having a transition requiring a level of inversion at a desired signal wavelength of the laser signal;
an inner cladding disposed adjacent to the core having an aspect ratio greater than 1.5 and configured sufficiently small to match a laser mode field geometry of the pump light to allow the inner cladding to optically deliver the pump light to the core at a high pump power density, the inner cladding having a cross-sectional area approximately 2 to 25 times larger than the core area to allow a sufficiently high overlap between dopants in the core and the pump light, such that the high pump power density and the high overlap between dopants and the pump light provide the required level of inversion for lasing with a low power threshold and high efficiency; and
an outer cladding disposed adjacent to the inner cladding having an index of refraction less than the inner cladding for confining the pump light.

20. A quasi-three-level emitting optical device comprising:
a high power pump source having a pump wavelength at about 1530 nm; and
a silicate glass host singly doped with tri-valent erbium (Er) ions having two bands of energy for in-band pumping by the high power pump source for absorption of Er from a ground level band to an energy band at an absorption bandwidth including 1530 nm for transitioning into emission from a manifold of the energy band back to the ground level band at an emission wavelength in an emission bandwidth, wherein the emission bandwidth is narrower than the absorption bandwidth but included within the absorption bandwidth such that the emission wavelength is less than 15 nm away from 1530 nm.
